(19) United States
(12) Patent Application Publication
(10) Pub. No.: US 2026/0367958 A1
(43) Pub. Date: Nov. 19, 2026

(54) SYSTEMS AND METHODS FOR USE OF A DOMAIN SPECIFIC LANGUAGE FOR EFFICIENT SEQUENTIAL ALGORITHMS ON AN ACCELERATED COMPUTING CO-PROCESSOR

(71) Applicant: Kinaxis Inc., Ottawa (CA)

(72) Inventor: Dane Henshall, Kemptville (CA)

(73) Assignee: Kinaxis Inc., Ottawa (CA)

(21) Appl. No.: 19/680,338

(22) Filed: May 18, 2026

Related U.S. Application Data
(60) Provisional application No. 63/806,817, filed on May 16, 2025.

(51) Int. Cl. G06F 9/455; G06F 8/41

(52) U.S. Cl. CPC G06F 9/45558; G06F 8/41

(57) ABSTRACT

Systems and methods for executing a function on an accelerated computing co-processor using a domain-specific language. Annotated program code that includes a call to the function designated for execution by the accelerated computing co-processor is received through a domain-specific language front end. The annotated program code is compiled to generate an intermediate representation that includes a load program request and a run function request. The load program request and the run function request are provided to a runtime application programming interface of a domain-specific language back end. A program is loaded onto a virtual machine associated with the accelerated computing co-processor, the function is invoked using input data, and a run function response that includes output data generated by the function is returned.

### CROSS-REFERENCE TO RELATED APPLICATION

This application claims priority to U.S. Provisional Patent Application 63/806,817 filed on May 16, 2025, which is incorporated herein in its entirety, by reference.

### BACKGROUND

High-performance computing on heterogeneous architectures (e.g., graphics processing units (GPUs) and tensor processing units (TPUs)) requires specialized low-level programming models to fully exploit hardware capabilities. These models separate high-level application logic from hardware-specific kernel implementations, forcing developers to maintain parallel code paths or translation layers across architectures. This fragmentation increases development overhead and the risk of inconsistencies and errors.

Runtime systems and compilation frameworks attempt to address these challenges using intermediate representations, dynamic scheduling, and just-in-time compilation. Techniques such as directed acyclic graphs, operation fusion, caching, and static analysis are used to optimize execution and map workloads across CPUs and accelerators. Some approaches further rely on domain-specific languages or abstraction layers to enable cross-architecture portability.

However, these solutions typically depend on compile-time knowledge of data structures, fixed dimensions, and static types. As a result, they struggle with dynamic workloads where data characteristics are only known at runtime. This limitation forces recompilation or multiple code variants and complicates validation, as host and accelerator implementations must be maintained separately. Overall, the lack of runtime adaptability and unified logic leads to inefficient, error-prone development and validation processes.

In summary, developing sequential algorithms for heterogeneous accelerators like GPUs and TPUs is laborious and error-prone, requiring complex low-level kernels and causing a separation between business logic and hardware implementation that complicates debugging. Existing approaches lack flexibility in handling dynamic data shapes and types at runtime.

### BRIEF SUMMARY

Disclosed herein are systems and methods that provide a context-aware Virtual Machine (VM) architecture featuring a Python-like Domain Specific Language (DSL) that decouples business logic from hardware specifics via a multi-stage compilation system. Functions are compiled into an Intermediate Representation (IR) where instructions embed synchronization context metadata. A lightweight VM running on the GPU interprets these instructions at runtime, dynamically managing memory allocation and handling data shapes and types unknown at compile time. The system utilizes a hierarchical execution model to automatically determine optimal execution contexts and It supports hybrid execution modes, allowing seamless switching between pure CPU Python, CPU-managed GPU execution, and direct GPU kernel invocation to enable immediate correctness validation without code duplication.

Disclosed herein is a technical solution (that addresses software development challenges) involving a context-aware VM architecture, a Domain Specific Language, and a multi-stage compilation system for heterogeneous accelerators. Specific technical features disclosed herein (for example, VM architecture, IR, synchronization metadata, a hierarchical execution model) improve computer functionality and hardware interaction.

In one aspect, a computing system is provided that includes one or more processors; an accelerated computing co-processor. The computing system also includes a memory storing instructions that, when executed by the one or more processors, configure the computing system to: receive program code includes a designation of a function for execution by the accelerated computing co-processor; generate, from the program code, an intermediate representation includes a program load request and a function execution request; provide the program load request and the function execution request to a runtime interface associated with the accelerated computing co-processor; load, via the runtime interface, a program onto a virtual machine associated with the accelerated computing co-processor; invoke, via the runtime interface, the function using input data identified by the function execution request; and return, via the intermediate representation, a response includes output data generated by execution of the function.

The computing system may also include where the accelerated computing co-processor is a GPU. The computing system may also include where the program load request includes a compiled program representation and static data for use during execution of the function. The computing system may also include where the function execution request includes the input data and execution metadata for invoking the function through the runtime interface. The computing system may also include where the instructions further configure the computing system to transform user-level data structures into representations compatible with the accelerated computing co-processor before the function is executed. The computing system may also include where the virtual machine includes an instruction buffer storing instructions corresponding to the function. The computing system may also include where the virtual machine executes an instruction interpreter to execute the function until a termination condition or an error condition is detected. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive program code includes a designation of a function for execution by the accelerated computing co-processor; generate, from the program code, an intermediate representation includes a program load request and a function execution request; provide the program load request and the function execution request to a runtime interface associated with the accelerated computing co-processor; load, via the runtime interface, a program onto a virtual machine associated with the accelerated computing co-processor; invoke, via the runtime interface, the function using input data identified by the function execution request; and return, via the intermediate representation, a response includes output data generated by execution of the function.

The non-transitory computer-readable storage medium may also include where the accelerated computing co-processor is a GPU. The non-transitory computer-readable storage medium may also include where the program load request includes a compiled program representation and static data for use during execution of the function. The non-transitory computer-readable storage medium may also include where the function execution request includes the input data and execution metadata for invoking the function through the runtime interface. The non-transitory computer-readable storage medium may also include where the instructions further configure the computing system to transform user-level data structures into representations compatible with the accelerated computing co-processor before the function is executed. The non-transitory computer-readable storage medium may also include where the virtual machine includes an instruction buffer storing instructions corresponding to the function. The non-transitory computer-readable storage medium may also include where the virtual machine executes an instruction interpreter to execute the function until a termination condition or an error condition is detected. Other technical features may be readily apparent to one skilled in the art from the following figures, descriptions, and claims.

In one aspect, a computer-implemented method is provided, that includes: receiving, by one or more processors, program code includes a designation of a function for execution by an accelerated computing co-processor; generating, by the one or more processors, from the program code, an intermediate representation includes a program load request and a function execution request; providing, by the one or more processors, the program load request and the function execution request to a runtime interface associated with the accelerated computing co-processor; loading, by the one or more processors, via the runtime interface, a program onto a virtual machine associated with the accelerated computing co-processor; invoking, by the one or more processors, via the runtime interface, the function using input data identified by the function execution request; and returning, via the intermediate representation, a response includes output data generated by execution of the function.

The computer-implemented method may also include where the accelerated computing co-processor is a GPU. The computer-implemented method may also include where the program load request includes a compiled program representation and static data for use during execution of the function. The computer-implemented method may also include where the function execution request includes the input data and execution metadata for invoking the function through the runtime interface. The computer-implemented method may further include transforming user-level data structures into representations compatible with the accelerated computing co-processor before the function is executed. The computer-implemented method may also include where the virtual machine includes an instruction buffer storing instructions corresponding to the function. The computer-implemented method may also include where the virtual machine executes an instruction interpreter to execute the function until a termination condition or an error condition is detected. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for use of a DSL for efficient sequential algorithms on an accelerated computing co-processor in accordance with one embodiment.

FIG. 2 illustrates a routine in accordance with one embodiment.

FIG. 3 illustrates a flowchart for use of a DSL for efficient sequential algorithms on an accelerated computing co-processor, in accordance with one embodiment.

FIG. 4 illustrates a system architecture for use of a domain specific language for efficient sequential algorithms on an accelerated computing co-processor, in accordance with one embodiment.

FIG. 5 illustrates system architecture of a DSL Front End in accordance with one embodiment.

FIG. 6 illustrates a flow chart for generation of an intermediate representation (IR) in accordance with one embodiment.

FIG. 7 illustrates system architecture of a DSL Back End in accordance with one embodiment.

FIG. 8 illustrates a dual framework for executing DSL programs, in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a "circuit," "module" or "system." Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to "one embodiment," "an embodiment," or similar language means that a particular feature, structure, or characteristic described in connection with the embodiment is included in at least one embodiment of the present disclosure. Thus, appearances of the phrases "in one embodiment," "in an embodiment," and similar language throughout this specification may, but do not necessarily, all refer to the same embodiment, but mean "one or more but not all embodiments" unless expressly specified otherwise. The terms "including," "comprising," "having," and variations thereof mean "including but not limited to" unless expressly specified otherwise. An enumerated listing of items does not imply that any or all of the items are mutually exclusive and/or mutually inclusive, unless expressly specified otherwise. The terms "a," "an," and "the" also refer to "one or more" unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a "software engine" or an "engine," refers to a software implemented system that provides an output that is different from the input. An engine can be an encoded block of functionality, such as a platform, a library, an object or a software development kit ("SDK"). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU) or a tensor processing unit (TPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network ("LAN") and a wide area network ("WAN").

The computing system can include clients and servers. A client and server are generally remote from each other and typically interact through a communication network. The relationship of client and server arises by virtue of computer programs running on the respective computers and having a client-server relationship to each other.

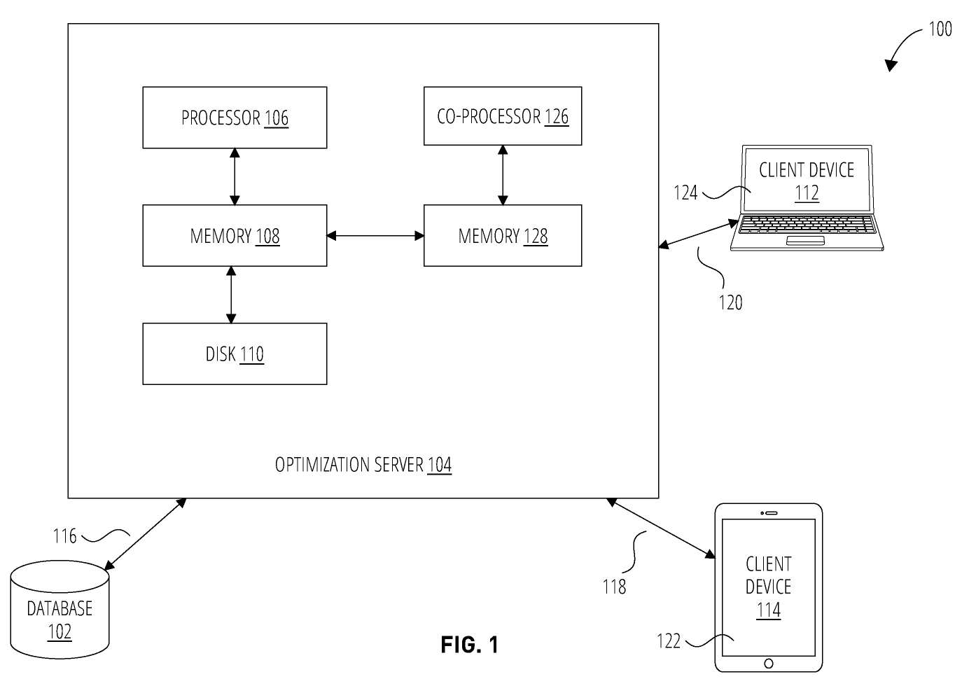

FIG. 1 illustrates an example of a system 100 for use of a DSL for efficient sequential algorithms on an accelerated computing co-processor in accordance with one embodiment.

System 100 includes an optimization server 104, a database 102, and client devices 112 and 114. Optimization server 104 can include one or more processors 106, a memory 108 associated with one or more processors 106, a disk 110, one or more co-processors 126 and a memory 128 associate with one or more co-processors 126. The one or more processors 106 interact with the one or more co-processors 126 via their respective memories 108 and 128. In some embodiments, memory 108 can be copied over to memory 128; calculations can be executed; and then memory 128 gets copied back to memory 108. In some embodiments, memory 108 can be volatile memory, compared with disk 110 which can be non-volatile memory. In some embodiments, similarly, memory 128 can be volatile memory, compared with disk 110 which can be non-volatile memory. In some embodiments, optimization server 104 can communicate with database 102 using interface 116. Database 102 can be a versioned database or a database that does not support versioning. While database 102 is illustrated as separate from optimization server 104, database 102 can also be integrated into optimization server 104, either as a separate component within optimization server 104, or as part of at least one of memory 108, memory 128 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108, memory 128 and disk 110. Storage media can include volatile and nonvolatile, removable and non-removable media implemented in any method or technology for storage of information such as computer-readable instructions, data structures, program modules or other data. Memory 108, memory 128 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, optimization server 104 can communicate with database 102 using interface 116. Optimization server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow optimization server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, optimization server 104can retrieve data from database 102. The retrieved data can be saved in disk 110, memory 108 or memory 128. In some cases, optimization server 104 can also include a web server, and can format resources into a format suitable to be displayed on a web browser. Optimization server 104 can then send requested data to client devices 112 and 114 via interfaces 120 and 118, respectively, to be displayed on applications 122 and 124. Applications 122 and 124 can be a web browser or other application running on client devices 112 and 114.

### Domain Specific Language (DSL) for Efficient Sequential Algorithms on an Accelerated Computing Co-Processor

Writing an accelerated computing co-processor code for sequential algorithms on an accelerated computing co-processor is very difficult and laborious - in particular, the need for validation to ensure efficient debugging. Examples of accelerated computing co-processors include a Graphical Processing Unit (GPU) and a Tensor Processing Unit (TPU). Existing DSLs do not generally support such a use case, which generally requires writing expensive-to-develop and difficult-to-debug kernels in a low-level accelerated computing co-processor kernel language. Developers often have to write complex, low-level code using tools such as Compute Unified Device Architecture (CUDA) or Open Computing Language (OpenCL), which are not easy to use.

A DSL for efficient sequential algorithms on an accelerated computing co-processor, can make development much easier by providing the following advantageous features:

Run any or all of the logic on a central processing unit (CPU), and compare to an accelerated computing co-processor for correctness. That is, allow parts of a program run on a regular computer (CPU) so results can be checked easily.

Allow the underlying precision to be changed by a runtime engine, so an algorithm developer does not need to be aware of their precision. That is, allow the system to handle numerical details (like precision) automatically.

Allow matrix/vector properties like sparse or dense representations to be chosen separately from the business logic of the algorithm whenever possible. That is, allow developers to choose how data is stored (for example, compact or full form) without changing the logic of the program.

Quickly identify the performance bottlenecks of the algorithm.

Make it easy to implement new high-level algorithms using simple, familiar syntax (for example, a simple internal DSL such as Python^{TM}).

Integrate cleanly with adjacent frameworks of the accelerated computing co-processor and DSLs (for example, JAX (Just-In-Time Compilation, Autograd, and Accelerated Linear Algebra)).

There is no technology available that provides most of these listed features, let alone all of them. Building out such a DSL and a high-performance runtime engine to support it, makes it much easier to develop and productize many complex algorithms, such as algorithms used for complex optimization problems.

Disclosed herein is a workflow that includes the following steps. Start by writing an algorithm that can benefit from use of faster hardware (for example, a GPU). The simple parts can be written as per usual (that is, using a CPU). Parts of the algorithm that should run on the faster hardware can be marked using special tags. Any fixed data needed for those fast parts can be registered. The program can then be converted into an internal format the system understands. The marked functions can be called; input data and instructions can be sent to a runtime system. The system can create a virtual environment on the accelerated computing co-processor (for example, a GPU); data can then be loaded, and the program runs. The system can keep running until it finishes or finds an error. The results can be copied back to the CPU. In addition, the results can be converted into a usable form and returned. The program can continue running without needing to reload everything.

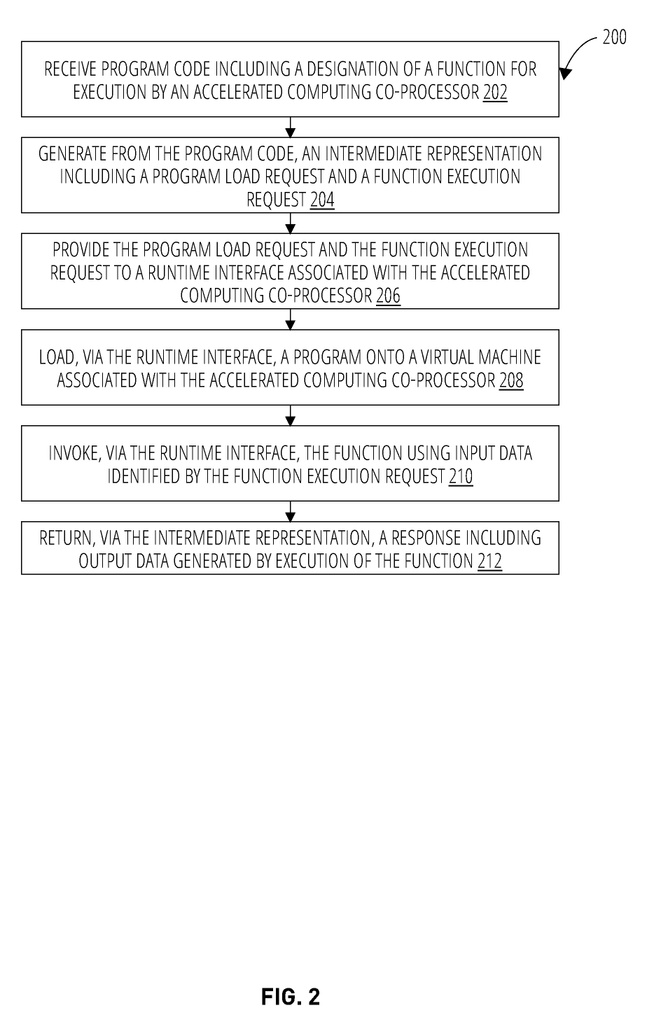

FIG. 2 illustrates a routine in accordance with one embodiment.

In block 202, routine 200 receives program code that includes a designation of a function for execution by an accelerated computing co-processor. In block 204, routine 200 generates from the program code, an intermediate representation that includes a program load request and a function execution request. In block 206, routine 200 provides the program load request and the function execution request to a runtime interface associated with the accelerated computing co-processor. In block 208, routine 200 loads via the runtime interface, a program onto a virtual machine associated with the accelerated computing co-processor. In block 210, routine 200 invokes via the runtime interface, the function using input data identified by the function execution request. In block 212, routine 200 returns a response that includes output data generated by execution of the function.

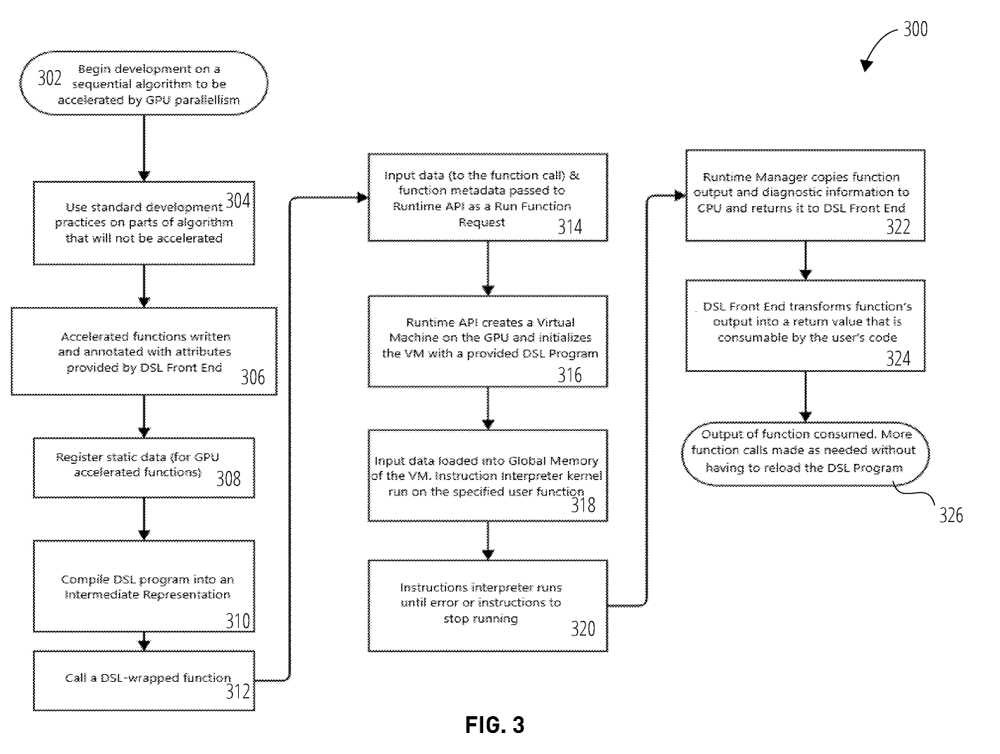

FIG. 3 illustrates a Flow Chart 300 for use of a DSL for efficient sequential algorithms on an accelerated computing co-processor, in accordance with one embodiment.

At 302, a user begins development on a sequential algorithm that they would like accelerated by parallelism with an accelerated computing co-processor (e.g. GPU, TPU). At this stage, the algorithm is written just like any regular program.

Next, at 304, the user develops the parts of the algorithm that do not need to be accelerated by an accelerated computing co-processor. The simpler parts are written and run using standard methods, without any special handling. This can be performed using standard development practices.

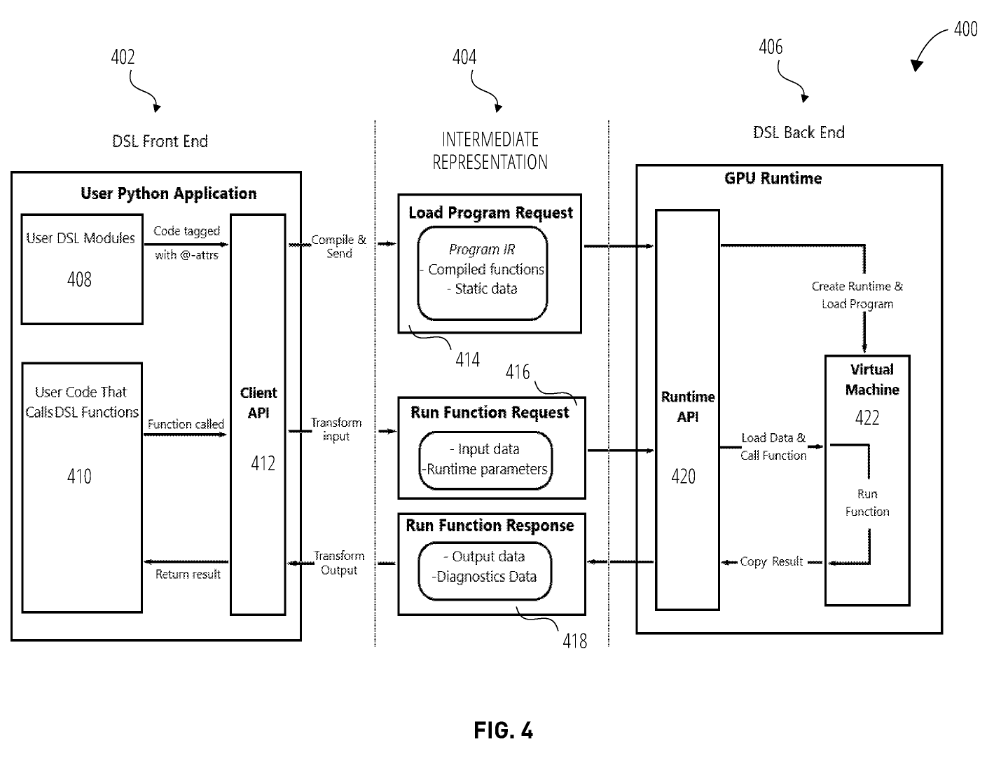

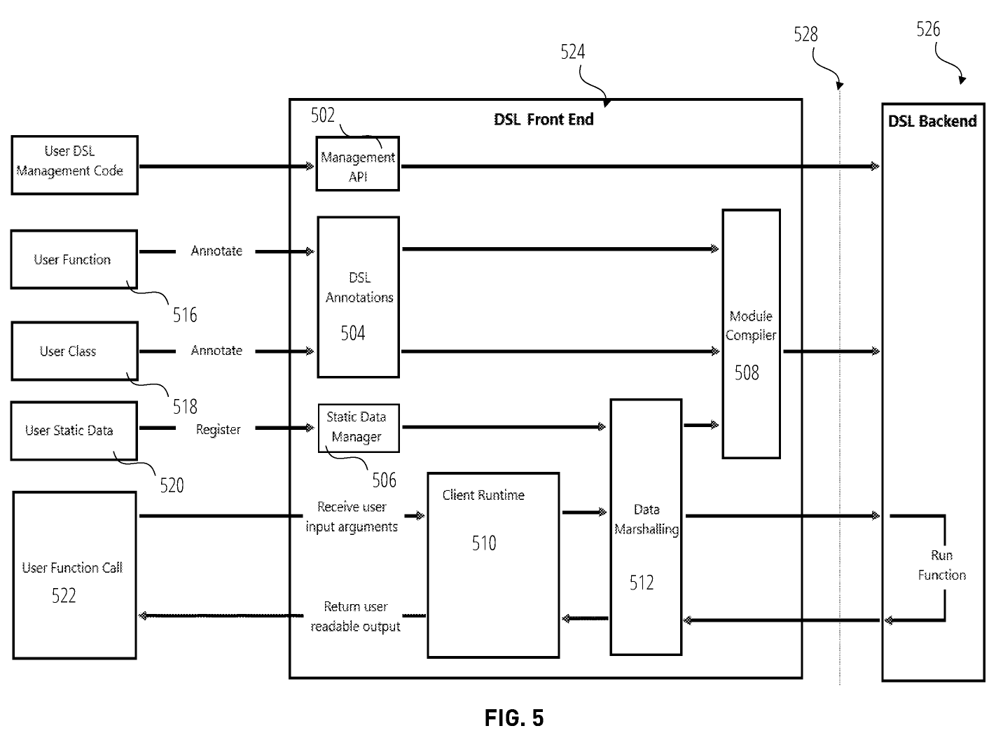

At 306, functions that need to be accelerated, are written and annotated with attributes provided by the DSL Front End (see FIGS. 4 and 5 for embodiments of a DSL Front End). For the parts that are slow or involve heavy computation, the developer adds simple labels (tags) to indicate that these parts should run on faster hardware.

At 308, any static data needed by the accelerated computing co-processor-accelerated functions, can be registered using attributes or by a Static Data API. That is, some data does not change while the program runs (for example, constants or lookup tables). This data can be registered so the system can easily access it when running the fast parts on the accelerated computing co-processor

Next at 310, the DSL program can be compiled into an Intermediate Representation (see FIG. 4 for an embodiment of an Intermediate Representation). This can be accomplished, either because the user has called a Management API function, or transparently by the DSL Front End when the user calls a DSL-wrapped function. That is, the system translates the program into a structured internal version (or internal representation) that it can understand and run efficiently. This happens automatically, either when requested or when the program is used.

When the program runs, it reaches one of the marked functions and calls it, just like calling any normal function, at 312. At 314, the input data to the function call, as well as the function metadata, is passed to the Runtime API as a Run Function Request. The runtime system manages execution.

Next at 316, the Runtime API creates a Virtual Machine (VM) on the accelerated computing co-processor and initializes it with the DSL program provided by the user. The runtime system creates a temporary environment on the accelerated computing co-processor and prepares it with the translated program.

At 318, the input data is then loaded into the VM's global memory. The instruction interpreter kernel can then be executed on the specified user function Next, at 320, the instruction interpreter runs until it encounters one of two situations: an error, or an instruction to stop running.

At 322, the Runtime Manager then copies the function output and diagnostic information to the CPU, and returns it to the DSL Front End. That is, once the function is complete, the results (and any diagnostic information) are sent back to the main computer (CPU).

At 324, the DSL Front end can transform the function's output into a return value that is consumable by the user's code. Finally, at 326, the user then consumes the output of the function, and proceeds to make more function calls as needed without having to reload the DSL Program.

In summary, a developer writes mostly normal code. Only the complex parts are marked for execution on an accelerated computing co-processor. The system automatically handles translation, execution on fast hardware, and returning results. This allows complex, high‑performance computing to be used without requiring the developer to manage low‑level details.

FIG. 4 illustrates a system architecture 400 in accordance with one embodiment. The general design includes DSL Front End 402, Intermediate Representation 404 and DSL Back End 406.

DSL Front End 402 is where a developer writes code. It includes DSL Modules 408, User Code (410) that calls DSL functions, and a Client API 412. The Client API 412 receives code that is annotated (or tagged) in the DSL Modules 408, along with functions called for execution on an accelerated computing co-processor. Tagging is a way for a developer to mark certain parts of the code as special, so the system knows they should be treated differently—usually to run faster on an accelerated computing co-processor (for example, a GPU) instead of the regular CPU. Tagging a function in the code informs the system a number of things, including: that the tagged part of the program is important for performance; to run this part on faster hardware if possible; and prepare this code in a special way before running it. In this manner, instead of rewriting the code in a completely different language, a developer can simply add a small marker. Client API 412 compiles and sends the annotated code, and transforms input (for called functions) to Intermediate Representation 404. In addition, Client API 412 receives transformed output and returns results to User Code (410).

Intermediate Representation 404 is a middle layer that stores the program in a structured format. It includes a Load Program Request 414, a Run Function Request 416, and a Run Function Response 418. The Load Program Request 414 can include a Program IR that includes compiled functions and static data. The Run Function Request 416 can include input data (for functions that will be run on DSL Back End 406) and runtime parameters. The Run Function Response 418 can include data output from DSL Back End 406 and diagnostics data. Run Function Response 418 is transformed and sent back to DSL Front End 402.

DSL Back End 406 runs the program on an accelerated computing co-processor (e.g. GPU, TPU). It can include a Runtime API 420 and a Virtual Machine 422. Runtime API 420 receives output from Load Program Request 414 and Run Function Request 416, while sending results from DSL Back End 406 to Run Function Response 418 of Intermediate Representation 404. The Runtime API 420 takes the output from Load Program Request 414, creating Runtime and loading a program onto Virtual Machine 422. It also takes output from Run Function Request 416, loading data and calling a function onto Virtual Machine 422, which then runs the function, and copies the result to Runtime API 420.

FIG. 5 illustrates a DSL Front End 524 implemented on the CPU-side, configured to provide a programming, compilation, and invocation interface for defining DSL programs and executing those programs on a GPU-resident backend.

The CPU-side is also labeled as the DSL Front End 524 and includes a number of DSL features. DSL Front End 524 can allow developers to write code using a simplified version of Python^{TM}. It supports normal programming features such as loops, conditions, and mathematical operations. Developers can organize code into functions and classes. By adding simple markers (annotations), functions can be prepared to run either on the CPU or an accelerated computing co-processor (such as GPU) automatically.

The DSL can use a subset of Python^{TM} syntax, so that a Python^{TM} parser and tooling made to support Python^{TM} -like languages, can be reused. This subset can include: all the standard control flow nodes (e.g. for, while, if, etc.), all the standard operators (e.g. +, -, @, ~, etc.), and a curated selection of library functions, that can have Python^{TM} and accelerated computing co-processor (e.g. GPU, TPU) implementations.

DSL functions may be organized into modules and classes, with ‘function’ being the base computation unit. For example, a DSL function can instantiate a DSL class and call another DSL function by name. DSL functions and classes may be marked with an @-annotation, that can cause them to be compiled into an Intermediate Representation 528 (IR) that can be callable in a number of ways. For example, on the CPU in Python^{TM} mode, which can execute a pure- Python^{TM} version of the function. Alternatively, on the CPU in an accelerated computing co-processor mode (such as GPU), which can copy to/from the accelerated computing co-processor and run it on device. In another example, directly on the accelerated computing co-processor (such as GPU) from a non-DSL GPU kernel code.

The DSL Front End 524 includes a collection of components that collectively receive user-defined DSL code and associated metadata, transform annotated code into an Intermediate Representation (IR), and coordinate invocation of the DSL Backend via a runtime interface.

The DSL Front End 524 includes mechanisms for defining DSL programs using a host-language syntax (e.g., a restricted subset of Python), wherein User Functions 516 and User Classes 518 are defined as primary computational constructs. Such constructs can be annotated using DSL Annotations 504 (e.g., @-annotations); annotations designate functions for compilation into the Intermediate Representation 528. The annotation mechanism provides identification of GPU-executable functions, and association of metadata required for compilation and execution (e.g., input/output structure).

The DSL Front End 402 includes a Module Compiler 508 configured to receive annotated DSL modules that include functions, classes, and static data. Module Compiler 508 is configured to transform the annotated constructs into Intermediate Representation 528. Furthermore, Module Compiler 508 is configured to produce a structured representation including: instruction buffers corresponding to function bodies, metadata describing function interfaces, and static data buffers. The Module Compiler 508 thereby can convert high-level DSL constructs into a form executable by the DSL Back End 526 virtual machine.

The DSL Front End 524 further includes a Static Data Registration and Management subsystem which includes a Static Data Manager 506 configured to register user-provided constant or configuration data, and mechanisms to incorporate such data into the Intermediate Representation 528as statically addressable buffers. User Static Data 520 may include model parameters, precomputed constants, or configuration arrays required by DSL functions. The static data is transmitted to DSL Back End 526 during program load and made accessible during execution.

The DSL Front End 402 exposes a Management API 502 configured to initiate compilation of DSL modules into Intermediate Representation 528. Management API 502 is also configured to issue Load Program Requests to the DSL Back Ends 526 and manage lifecycle operations of DSL programs (e.g., initialization and loading). The Management API 502 enables both explicit compilation and loading initiated by user code; and implicit compilation triggered upon first invocation of a DSL-wrapped function.

The DSL Front End 524 includes a Client Runtime 510 responsible for executing DSL functions from user code. With regards to function call handling, upon invocation of a DSL-wrapped function, user input arguments are received and captured. Subsequently, a Run Function Request is constructed, including input data, and execution metadata. As for data marshalling, A Data Marshalling 512 component transforms user-level data structures into backend-compatible representations, including conversion to appropriate memory layouts, and packaging into buffers suitable for GPU transfer.

The DSL Front End 524 interacts with the backend through a Runtime API (see, for example, Runtime API 420 in FIG. 4), which: transmits Run Function Requests to the DSL Back End 526; receives execution results and diagnostic information, and provides synchronization between CPU-side and GPU-side execution.

Upon receipt of execution results from the DSL Back End 526, the DSL Front End 524 performs output transformation, converting backend data representations into user-consumable forms, and return of the transformed output to the calling application code (User Function Call 522). This ensures transparency between DSL execution and host-language usage.

The operation of the DSL Front End 524 can be summarized as follows. DSL Definition is initiated when a user defines functions/classes (at User Function 516 and User Class 518) using DSL syntax with annotations. Compilation occurs when Module Compiler 508 converts annotated code (from DSL Annotations 504) into Intermediate Representation 528 Static data (from User Static Data 520) is registered (via Static Data Manager 506) and incorporated into IR buffers. Program Loading occurs when Management API 502 issues a Load Program Request to DSL Back End 526. Function Invocation occurs when Client Runtime 510 captures inputs (from User Function Call 522) and generates a Run Function Request. Data Marshalling 512 transforms inputs into GPU-compatible representations. Execution Coordination is managed via a Runtime API that sends request to DSL Back End 526 and awaits completion. Results are transformed and returned to the user.

Within the broader DSL system (FIG. 4), the DSL Front End 524 serves as: a high-level programming interface, a compiler from DSL constructs to IR, and a runtime coordinator for function invocation and data transfer. FIG. 5 defines a CPU-resident DSL Front End architecture that accepts annotated user-defined computational logic. This architecture compiles such logic into an intermediate executable representation, and orchestrates execution on a GPU-based backend through structured APIs. The DSL Front End 524 thereby facilitates separation between high-level algorithm specification, and low-level parallel execution, while enabling transparent invocation of GPU-accelerated functionality from host-language code.

The system converts programs into an internal format, or an Intermediate Representation (for example, 404 in FIG. 4), made up of modules, functions, and data. Functions in the IR contain instructions that describe what needs to be done. These instructions also include information about how different steps depend on each other, ensuring tasks run in the correct order.

Generally, DSL programs disclosed herein can be represented as a collection of modules. Each module may be a collection of classes, functions, and module level static data. Classes are a cosmetic wrapper around collections of functions, primarily to improve readability and organization of code, and have no representation in Intermediate Representation 404.

Functions can be represented by input and output structure meta-data, an id, and the body of the function which is an Instruction Block, represented as offsets into an Instruction Buffer.

An Instruction Block is an ordered list of instructions, analogous to a traditional function. A unique feature of DSL instructions disclosed herein is that they include information on the context they need to be synchronized with.

For example, element-wise instructions do not require any synchronization between processing units, whereas an operation that computes the sum across a vector requires that (a) all previous instructions that write to the input are completed before it executes, and (b) all future instructions that consume the output of the operation wait until the operation has been fully executed. The Instruction Buffer can be a flat representation of all the Instruction Blocks of the program. A static data buffer can be a flat representation of all the data that is statically compiled into the program.

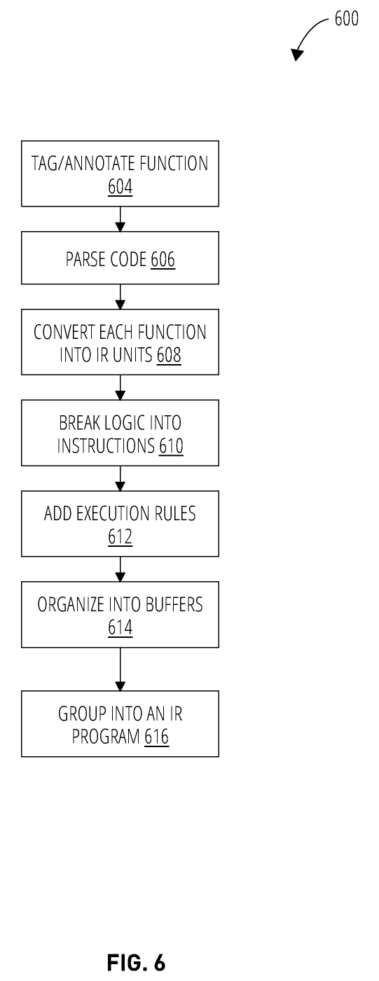

FIG. 6 illustrates a flow chart 600 for generation of an intermediate representation (IR) in accordance with one embodiment.

The Intermediate Representation (IR) is created automatically by the system when tagged (annotated) functions are prepared for execution. The IR is used to convert simple, developer-written code into a structured format that the runtime can execute efficiently on an accelerated computing co-processor, such as a GPU. With respects to Flow Chart 300, IR generation happens at Step 310, after functions are tagged/annotated and before execution begins.

The process of IR generation begins at block 604 when a developer marks certain functions with tags (annotations). A tag on a function signals that the function should be handled by the DSL system. Furthermore, only tagged functions are converted into IR. At this point, the code still has a structure of a conventional Python‑style code.

At block 606, the code is parsed into a structured form. The DSL front end (for example 402 in FIG. 4 or 524 in FIG. 5) reads the tagged/annotated code and breaks it down into its basic components that can include functions; inputs and outputs; and operations (for example: add, loop, condition). Since the DSL uses a subset of Python, existing Python parsing tools can be reused.

At block 608, the functions are converted into IR units. Each tagged function is transformed into a structured IR representation, that can include: a function ID (unique identifier); input/output descriptions; and a body made of instructions. Instead of raw code, each function (that is to be executed on an accelerated computing co-processor) is now expressed as a sequence of well-defined steps.

At block 610, logic is broken into a set of instructions. The function body can be converted into small building blocks, labelled as instructions. Examples of instructions include: perform an operation (e.g., add two values), loop over elements, and combine results (e.g., sum values). Each instruction can be placed in an instruction block, much like a list of steps to execute.

Add block 612, execution rules (dependencies) are added. A part of IR generation is adding information about how steps depend on each other. For example, some steps can run independently, while some steps must wait until others finish. Such dependency information ensures correct execution order and efficient parallel execution.

The developer does not have to manage these decisions/steps manually.

At 614, everything is organized into buffers. The system stores the IR in organized structures, that can include: an instruction buffer (which includes all instructions in the program); a static data buffer (that includes fixed data used by functions); and function metadata (that includes inputs, outputs, and structure). These can be flattened into simple, structured formats that are easy to load onto the accelerated computing co-processor (for example, a GPU).

At block 616, the program is packaged as IR. Everything is grouped into a complete IR program, that includes a collection of modules, where each module contains functions and data, which is ready to be sent to the runtime system. This IR serves as a bridge between the DSL front end and the accelerated computing co-processor execution.

In summary, IR generation provides translating tagged, human‑readable code into a structured, machine‑friendly set of instructions with execution rules. IR generation allows developers to write simple, high-level code. The system converts it into a format optimized for performance. The same IR can run on CPU for testing and an accelerated computing co-processor for speed. This separation allows for ease of use and high performance at the same time.

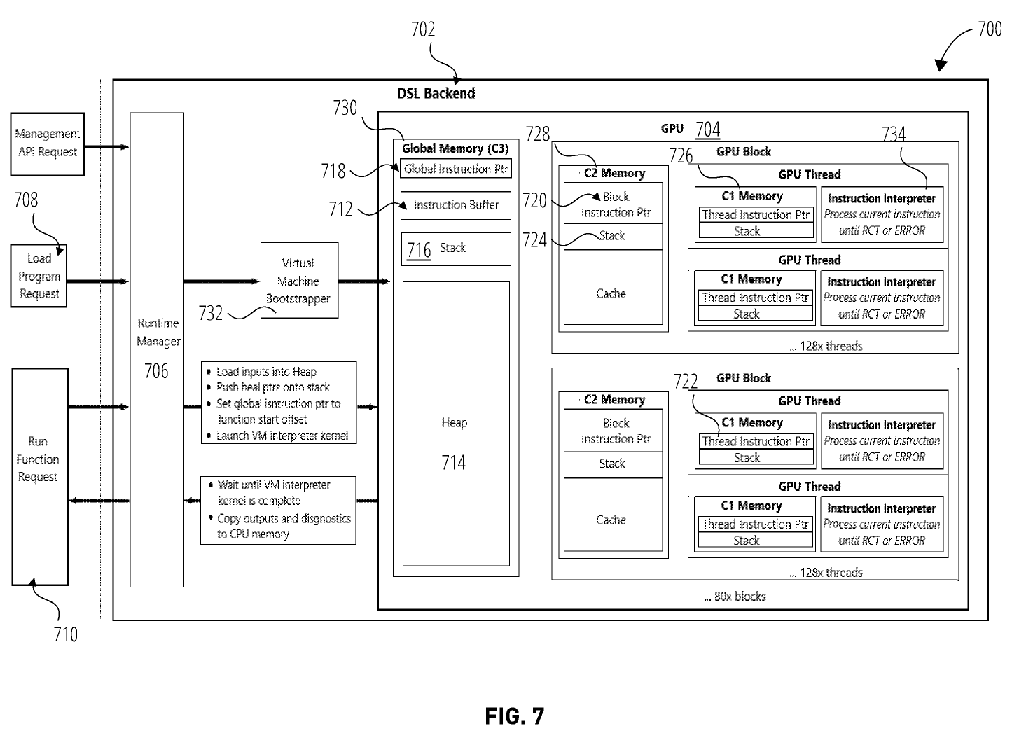

FIG. 7 illustrates system architecture 700 of a DSL Backend 702 in accordance with one embodiment. In FIG. 7, a DSL Backend 702 is implemented on a graphics processing unit (GPU 704) as a runtime execution environment that includes a virtual machine (VM) configured to interpret and execute an intermediate representation (IR) of a DSL program. The GPU-side runtime can be a light-weight virtual machine (VM). However, there is an option in the design to compile a Hardware Accelerated Linear Optimization DSL program directly to the native instruction set.

A lightweight virtual machine on the accelerator enables runtime instruction execution, eliminating recompilation for dynamic data shapes and types. Embedding synchronization metadata in a flat instruction buffer explicitly defines dependencies, allowing adaptive execution across threads, blocks, devices, and host systems. This supports seamless switching between host and accelerator execution for direct correctness validation without code duplication.

Instructions can be organized as blocks referencing offsets in the buffer, with runtime validation of input dimensions and types. Dynamic memory allocation on the co-processor enables flexible handling of sparse and dense data. By assigning execution units based on operation type and managing synchronization at the appropriate level, the system avoids rigid kernel constraints and performance bottlenecks. Overall, the architecture decouples high-level logic from hardware specifics while maintaining efficient, consistent execution across heterogeneous environments.

Running a program in the VM may require the following steps: loading an instruction buffer and static data buffers into GPU memory; allocating heap and stack regions in GPU memory; and copying the input data for the function call into the heap region of the VM. An important point is that data shape and data type are not known at compile time. Handling different shapes or types is the responsibility of the program runtime. For example, if executing a vector-add instruction, the runtime needs to ensure that the lengths of the two vectors match. If the lengths match, then the addition is executed in a way that is aware of the data types of the vectors. It may also be necessary to allocate or re-allocate the output vector.

The DSL Backend 702 can be structured to receive management and execution requests from a front-end runtime, instantiate and maintain a GPU-resident VM, and execute DSL functions by interpreting instruction buffers in a massively parallel manner across GPU execution units. Each of these is discussed below.

With regards to receiving management and execution requests, DSL Backend 702 includes a Runtime Manager 706 configured to process at least two request types. In FIG. 7, Load Program Request 708 and Run Function Request 710 are shown.

The Runtime Manager 706, upon receiving a load request (from Load Program Request 708), can be configured to instantiate the virtual machine, load an Instruction Buffer 712 and optional static data into GPU memory, and allocate Heap 714 and Stack 716 memory regions for runtime execution. Upon receiving a run function request from 710 the Runtime Manager 706 can be further configured to copy input arguments into the VM Heap 714, initialize execution state (including instruction pointers and stack frames), launch a GPU kernel implementing an instruction interpreter, and synchronize on kernel completion before transferring results back to host memory. The Runtime Manager 706 thereby serves as a control plane bridging host-side execution requests and device-side parallel execution.

With regards to VM architecture, the DSL Backend 702 provides a GPU-resident virtual machine that includes a number of components, such as an Instruction Buffer 712, Instruction Pointers (Global Instruction Pointer: 718, Block Instruction Pointer 720 and Thread Instruction Pointer 722), Heap Memory, Stack Memory and Memory Hierarchy.

Instruction Buffers 712 can be a contiguous memory structure storing a flattened representation of instruction blocks corresponding to DSL functions. Each instruction can include execution semantics and context requirements. Functions can be represented as entry points referencing offsets into the Instruction Buffer 712.

The VM can maintain multiple levels of instruction pointers. In the embodiment shown in FIG. 7, there is a Global Instruction Pointer: 718 that identifies the starting offset of the currently invoked function. Furthermore, there is a Block Instruction Pointer 720 that coordinates execution at the thread-block level. In addition, there is a Thread Instruction Pointer 722 that enables each thread to track its position during instruction interpretation. This hierarchical pointer structure can support fine-grained parallel interpretation of the same instruction stream across multiple execution units.

The VM includes a dynamically managed heap region which can be configured to store input data, intermediate computation results, and output data structures. The Heap 714 can supports runtime allocation and reallocation, necessitated by the absence of compile-time guarantees regarding data shape and type.

The VM further includes a stack region 716 which can be used to store references (e.g., heap pointers) pushed prior to execution, maintain call frames and local variables, and enable nested or recursive instruction execution patterns. Each thread may additionally maintain a thread-local stack to support independent execution contexts within the parallel interpreter. Each thread may additionally maintain a thread-local stack 724 to support independent execution contexts within the parallel interpreter.

In the embodiment shown in FIG. 7, there is a Memory Hierarchy (C1 / C2 / C3). FIG. 12 distinguishes between multiple GPU memory tiers. For example, C1 Memory 726 is thread-local or cache memory storing instruction pointers and frequently accessed state. C2 Memory 728 is a shared VM memory containing instruction buffers, heap, and stack regions. C3 (Global Memory) 730 is device-wide memory storing globally visible state such as global instruction pointers. Heap Memory is C2 Memory, while Stack Memory is a C2 Memory and Per-Thread Stacks. This hierarchical organization enables efficient access patterns for interpreter execution across GPU threads and blocks.

DSL Backend 702 includes a bootstrapper functionality. A Bootstrapper 732 is provided to initialize the virtual machine during program loading. The Bootstrapper 732 is configured to load the instruction buffer into GPU memory, initialize heap and stack regions (714 and 716, respectively), and prepare global execution state prior to function invocation.

DSL Backend 702 also includes an Instruction Interpreter Kernel. Execution is performed by an instruction interpreter 734 implemented as a GPU kernel, which can be launched across multiple thread blocks (e.g., up to 80 blocks), each containing multiple threads. Furthermore, each instruction interpreter 734 can be configured such that each thread executes a loop as follows: fetch instruction via a thread instruction pointer, decode and execute the instruction, and advance the pointer until a termination condition is met. The instruction interpreter 734 continues execution until a termination instruction is encountered (e.g., return condition), or an error condition is detected.

Function Invocation Semantics can be handled by DSL Backend 702. Upon receiving a run request, execution can proceed with the following steps. First, Input is marshalled as input data is copied into the VM Heap 714. Next, there is stack initialization as heap pointers corresponding to inputs are pushed onto the Stack 716. This is followed by instruction pointer initialization as the global Block Instruction Pointer 720 is set to the offset corresponding to the target function. Next is kernel execution, as the interpreter kernel is launched across threads and blocks. This is followed by parallel instruction execution as instructions are executed subject to their context and synchronization semantics (e.g., element-wise vs reduction). Next is completion and synchronization as Runtime Manager 706 waits for kernel completion. Finally, there is a result transfer as outputs and diagnostic information are copied from device memory to host memory.

The DSL Backend 702 embodies several distinguishing execution model characteristics. For one, there is an interpretation-based execution: rather than compiling directly to native GPU instructions, the backend executes programs via an interpreter, enabling flexibility in handling dynamic data shapes and types. Furthermore, there is parallelized interpretation, in that the interpreter itself is parallelized, allowing instruction processing to scale with GPU hardware resources (threads, thread groups, blocks). In addition, there is context-aware execution, in that instructions encode synchronization requirements, enabling lock-free execution for element-wise operations, and coordinated execution for reductions or dependent operations.

Another distinguishing feature of the embodiment of DSL Backend 702 is runtime adaptation. The VM can dynamically validate operand shapes and types, select execution strategies, and allocates output structures as required.

FIG. 7 illustrates an embodiment of a GPU-native virtual machine architecture that decouples DSL program specification from hardware-specific implementation, enables dynamic, context-aware execution of IR instructions, and leverages GPU parallelism through a distributed interpreter model. DSL Backend 702 provides an execution substrate that transforms DSL-defined algorithms into runtime-executable parallel workloads, while preserving flexibility in data representation and execution strategy.

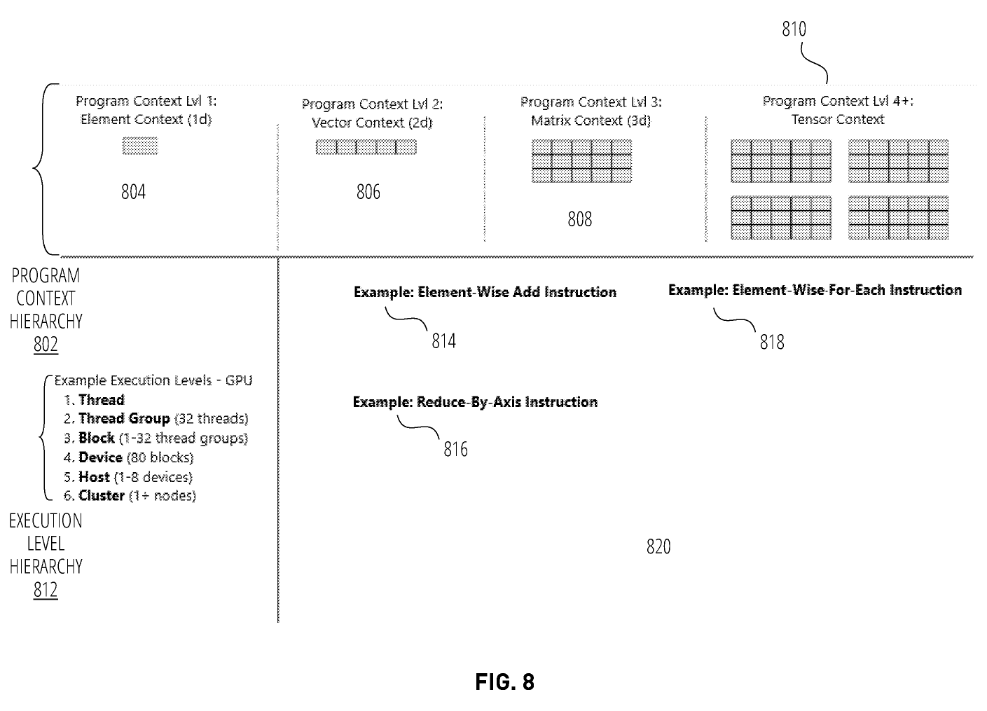

FIG. 8 illustrates a dual framework for executing DSL programs, in accordance with one embodiment. FIG. 8 illustrates how work is organized and executed at different scales, from very small pieces of data to large computing systems, and how different types of operations fit into that structure. The dual framework includes a program context hierarchy 802 and an execution level hierarchy 812.

Program context hierarchy 802 defines the dimensional structure over which instructions operate. That is, computations can operate on data of increasing size and complexity, beginning at the lowest level, Level 1 (804) which is a 1-dimensional context and refers to a single value (for example, one number). Here, each operation applies independently to individual scalar elements. Next is Level 2 (806) which is a 2-dimensional context and refers to a vector (for example, a list of numbers). Operations are defined over one-dimensional collections of elements. After Level 2 (806) is Level 3 (808), which is a 3-dimensional context and refers to a matrix (for example, a 2-dimensional table of numbers). Operations are applied across two-dimensional structured data. After Level 3 (808) is Level 4+ (810), which is a 4+ - dimensional context and refers to a tensor (for example, higher-dimensional data such as multiple layers of tables). Operations extend to higher-dimensional data structures.

The program context specifies the granularity and dimensional scope of computation. It also defines implicit parallelization opportunities (e.g., independent element-wise execution). Thus, the context provides a logical execution domain independent of the underlying hardware.

Execution level hierarchy 812 defines the mapping of such operations onto GPU hardware resources. Execution level hierarchy 812 includes a thread, which is the smallest execution unit. Next is a thread group (or warp), which is a collection of threads (e.g., up to 32 threads). This is followed by a block, which is a grouping of one or more thread groups. A block can include between 1-32 thread groups. Next is a device, which can be a full GPU, that includes multiple blocks. A device can include up to 80 blocks. The next level is a host, which is a system containing one or more devices. A host can include 1-8 devices. This level is followed by a cluster, which is a distributed system of 1 or more nodes. The system can scale from a single thread to a cluster working together.

Execution level hierarchy 812 defines physical parallel resources available, and determines synchronization scope and communication constraints. A feature of the framework illustrated in FIG. 13 is the decoupling between the program context (logical data structure), and the execution level (hardware mapping).

The execution level of an instruction can be either specified by the instruction itself, or left to the Virtual Machine to determine the best execution level to target the instruction. That is, different types of operations are best handled at different levels. Three examples are shown at 820: Element-Wise Add instruction (814), Reduce-by-Axis Instruction (816); and Element-Wise-For-Each Instruction (818).

Element-Wise Add instruction (814) adds values one-by-one (e.g., add two lists element-by-element); each value can be handled independently. That is, many threads can each handle one number at a time. For primitive element-wise operations, synchronization is only required at the thread level. The instructions can be executed at the thread level without any synchronization. This enables fully parallel execution across threads with minimal overhead.

Reduce-by-Axis Instruction (816) combines many values into one (e.g., sum a row of numbers), requiring coordination to combine results. That is, threads, thread groups and blocks collaborate and combine results, not just work independently. A 1-dimensional reduce-by-axis instruction (for example, sum the rows of a matrix) can include a reduction operation, and can be executed at several different context levels. Each output element can be processed in parallel, but synchronization may be required to compute the value of an individual output element.

If the computation is kept local to a specific GPU device, each row can be assigned a thread, a Thread Group, Block, or a whole device. The implementation of sum-by-axis is different for each of these execution levels. However, generally speaking, the execution unit assigned to a current row will compute the result for that row before it moves onto the next row.

Element-Wise-For-Each Instruction (818) applies a function to each element; that function itself may contain more work. This instruction calls a function once for each element. The function must be able to run in parallel on each element. Amy synchronization required between elements can be handled by the logic of the function.

If the computation is kept local to a specific GPU device, then such an element can be assigned a thread, a group thread, a block or the whole device, in a manner similar to the reduce-by-axis instruction example 816. The difference here, however, is that the function called may be a user function that itself uses instructions, or sub-functions that are going to be parallelized.

For example, if the for-each instruction assigns each element to a block, then the user function will not have access to the Device execution level (see execution level hierarchy 812). All of the instructions run within the function call are assigned to the Block, Thread Group, or Thread execution levels. If this user function contains another Elementwise-For-Each instruction that targets the Target Group level, then during the execution of that nested function instructions will be limited to the Thread or Thread Group execution levels.

The context abstraction enables encoding of synchronization requirements within instructions, as shown in the above three examples. Element-wise operations require no synchronization, reduction operations require intra-group synchronization, and composite operations may impose nested synchronization constraints. This approach allows the runtime to enforce correctness, and optimize execution placement across GPU resources.

In summary, FIG. 8 illustrates a mapping between three entities: the type of data being processed (from small to very large as shown by program context hierarchy 802); how much computing power is available (from one thread to a cluster of many machines, as shown by execution level hierarchy 812); and the type of operation is being performed (simple vs coordinated as shown in examples 820). The system, illustrated for example in FIG. 4, selects the right level of parallelism, runs each operation where it works best, and automatically scales from tiny tasks to massive computations. FIG. 8 illustrates how the system scales computations across different data sizes and hardware levels, and assigns each type of operation to the most appropriate level of parallel execution.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing system comprising:
one or more processors;
an accelerated computing co-processor; and
a memory storing instructions that, when executed by the one or more processors, configure the computing system to:
receive program code comprising a designation of a function for execution by the accelerated computing co-processor;
generate, from the program code, an intermediate representation comprising a program load request and a function execution request;
provide the program load request and the function execution request to a runtime interface associated with the accelerated computing co-processor;
load, via the runtime interface, a program onto a virtual machine associated with the accelerated computing co-processor;
invoke, via the runtime interface, the function using input data identified by the function execution request; and
return, via the intermediate representation, a response comprising output data generated by execution of the function.

2. The computing system of claim 1, wherein the accelerated computing co-processor is a Graphical Processing Unit (GPU).

3. The computing system of claim 1, wherein the program load request comprises a compiled program representation and static data for use during execution of the function.

4. The computing system of claim 1, wherein the function execution request comprises the input data and execution metadata for invoking the function through the runtime interface.

5. The computing system of claim 1, wherein the instructions further configure the computing system to transform user-level data structures into representations compatible with the accelerated computing co-processor before the function is executed.

6. The computing system of claim 1, wherein the virtual machine comprises an instruction buffer storing instructions corresponding to the function.

7. The computing system of claim 1, wherein the virtual machine executes an instruction interpreter to execute the function until a termination condition or an error condition is detected.

8. A non-transitory computer-readable storage medium, the computer-readable storage medium including instructions that when executed by a computer, cause the computer to:
receive program code comprising a designation of a function for execution by the accelerated computing co-processor;
generate, from the program code, an intermediate representation comprising a program load request and a function execution request;
provide the program load request and the function execution request to a runtime interface associated with the accelerated computing co-processor;
load, via the runtime interface, a program onto a virtual machine associated with the accelerated computing co-processor;
invoke, via the runtime interface, the function using input data identified by the function execution request; and
return, via the intermediate representation, a response comprising output data generated by execution of the function.

9. The non-transitory computer-readable storage medium of claim 8, wherein the accelerated computing co-processor is a Graphical Processing Unit (GPU).

10. The non-transitory computer-readable storage medium of claim 8, wherein the program load request comprises a compiled program representation and static data for use during execution of the function.

11. The non-transitory computer-readable storage medium of claim 8, wherein the function execution request comprises the input data and execution metadata for invoking the function through the runtime interface.

12. The non-transitory computer-readable storage medium of claim 8, wherein the instructions further configure the computing system to transform user-level data structures into representations compatible with the accelerated computing co-processor before the function is executed.

13. The non-transitory computer-readable storage medium of claim 8, wherein the virtual machine comprises an instruction buffer storing instructions corresponding to the function.

14. The non-transitory computer-readable storage medium of claim 8, wherein the virtual machine executes an instruction interpreter to execute the function until a termination condition or an error condition is detected.

15. A computer-implemented method comprising:
receiving, by one or more processors, program code comprising a designation of a function for execution by an accelerated computing co-processor;
generating, by the one or more processors, from the program code, an intermediate representation comprising a program load request and a function execution request;
providing, by the one or more processors, the program load request and the function execution request to a runtime interface associated with the accelerated computing co-processor;
loading, by the one or more processors, via the runtime interface, a program onto a virtual machine associated with the accelerated computing co-processor;
invoking, by the one or more processors, via the runtime interface, the function using input data identified by the function execution request; and
returning, via the intermediate representation, a response comprising output data generated by execution of the function.

16. The computer-implemented method of claim 15, wherein the accelerated computing co-processor is a Graphical Processing Unit (GPU).

17. The computer-implemented method of claim 15, wherein the program load request comprises a compiled program representation and static data for use during execution of the function.

18. The computer-implemented method of claim 15, wherein the function execution request comprises the input data and execution metadata for invoking the function through the runtime interface.

19. The computer-implemented method of claim 15, further comprising:
transforming user-level data structures into representations compatible with the accelerated computing co-processor before the function is executed.

20. The computer-implemented method of claim 15, wherein the virtual machine comprises an instruction buffer storing instructions corresponding to the function.
